(19) United States
(12) Patent Application Publication
(10) Pub. No.: US 2015/0006793 A1
(43) Pub. Date: Jan. 1, 2015

(54) STORAGE SYSTEM AND OPERATING METHOD THEREOF

(71) Applicant: SAMSUNG ELECTRONICS CO., LTD., Suwon-si (KR)

(72) Inventors: Hyun-jung SHIN, Yongin-si (KR); Jung-Min SEO, Seongnam-si (KR); Ju-Pyung LEE, Suwon-si (KR)

(73) Assignee: SAMSUNG ELECTRONICS CO., LTD., Suwon-si (KR)

(21) Appl. No.: 14/319,327

(22) Filed: Jun. 30, 2014

(30) Foreign Application Priority Data
Jun. 28, 2013 (KR) 10-2013-0075953

(51) Int. Cl. G06F 3/06

(52) U.S. Cl. CPC G06F 3/0641; G06F 3/0608; G06F 3/0679
USPC 711/103; 711/159

(57) ABSTRACT

Provided are a host device, a storage device, a storage system and operating methods thereof. The host device includes a duplicated information updater configured to update pre-stored duplicated information in response to a write request or a delete request for duplicated data, and a transferor configured to transfer the updated duplicated information to a storage device in which the same data as the duplicated data is stored.

### CROSS-REFERENCE TO RELATED APPLICATION

This application claims priority from Korean Patent Application No. 10-2013-0075953 filed on Jun. 28, 2013 in the Korean Intellectual Property Office, the contents of which are herein incorporated by reference in its entirety.

### BACKGROUND

1. Field

Exemplary embodiments relate to a host device, a storage device, a storage system, and operating methods thereof.

2. Description of the Related Art

Deduplication is a related art technique that enables efficient management of duplicated data by managing and operating the same data using link values without storing duplicated data. The related art deduplication technique may be used in a storage system with large capacity data because it can improve storage utilization efficiency and can reduce data transferred to a network.

Examples of the related art deduplication technique applied to a storage system configured by a solid state drive or a solid state disk (SSD) may be divided into two cases: deduplication directly performed by the SSD for storage; and deduplication performed outside of the SSD (e.g., a server or a host).

In the deduplication directly performed by the SSD for storage, since a write operation is performed in units of pages, block-level deduplication is performed. However, in the deduplication directly performed by the SSD for storage, there is a limit in performing deduplication due to limited capacities of a CPU and a memory of the SSD. In a case of a storage system consisting of multiple SSDs, deduplication cannot be performed on data blocks overlapping with other SSDs.

In the deduplication performed outside of the SSD, only deduplicated is written on the SSD. In this case, block-level deduplication can be performed in a more elaborate manner and a file-level deduplication can also be performed. However, in this case, since the SSD cannot determine whether input data is deduped data or unique data, deduplication cannot be utilized for data placement in the SSD.

### SUMMARY

Exemplary embodiments provide a host device, a storage device, a storage system, and operating methods thereof.

The above and other objects of the exemplary embodiments will be described in or be apparent from the following description of the preferred embodiments.

According to an aspect of the exemplary embodiments, there is provided a host device including a duplicated information updater which is configured to update pre-stored duplicated information in response to a write request or a delete request for duplicated data, and a transferor which is configured to transfer the updated duplicated information to a storage device in which the same data as the duplicated data is stored.

According to another aspect of the exemplary embodiments, there is provided a storage device of a storage system, the storage device including a receiver which is configured to receive the duplicated information from the host device, and a data placer which is configured to place data based on the received duplicated information.

According to still another aspect of the exemplary embodiments, there is provided a storage system including a host device which is configured to update pre-stored duplicated information in response to a write request or a delete request for duplicated data and transfer the updated duplicated information to a storage device, and a storage device which is configured to store the updated duplicated information by receiving the updated duplicated data from the host device and place data based on the stored duplicated information.

According to yet another aspect of the exemplary embodiments, there is provided a method of operating a host of a storage system including determining whether write-requested data is duplicate data, performing deduplication on the write-requested data in response to the determining that the write-requested data is the duplicate data; updating duplicated information of a pre-stored data which is the same data as the write-requested data in response to the performing the deduplication on the write-requested data, and transferring the updated duplicated information to a storage device in response to the updating the duplicated information.

### BRIEF DESCRIPTION OF THE DRAWINGS

The above and other features and advantages of the exemplary embodiments will become more apparent by describing in detail preferred embodiments thereof with reference to the attached drawings in which:

FIG. 1 is a schematic diagram of a storage system according to an embodiment;

FIG. 2 is a schematic diagram of a storage system according to another embodiment;

FIG. 3 is a detailed diagram of a host shown in FIG. 1;

FIG. 4 is a detailed diagram of a storage device shown in FIG. 1;

FIGS. 5A to 5E illustrate a method of transferring duplicated information according to an embodiment;

FIGS. 6A and 6B illustrate methods of operating mapping tables in a host and a storage device;

FIG. 7 is a flowchart illustrating a method of operating a host in response to a data write request according to an embodiment;

FIG. 8 is a flowchart illustrating a method of operating a host in response to a data delete request according to an embodiment;

FIG. 9 is a flowchart illustrating a method of operating a storage device according to an embodiment; and

FIG. 10 is a flowchart illustrating a method of operating a storage system according to an embodiment.

### DETAILED DESCRIPTION OF THE EXEMPLARY EMBODIMENTS

Advantages and features of the exemplary embodiments and methods of accomplishing the same may be understood more readily by reference to the following detailed description of preferred embodiments and the accompanying drawings. The exemplary embodiments may, however, be embodied in many different forms and should not be construed as being limited to the embodiments set forth herein. Rather, these embodiments are provided so that this disclosure will be thorough and complete and will fully convey the concept of the exemplary embodiments to those skilled in the art. The exemplary embodiments will only be defined by the appended claims Like reference numerals refer to like elements throughout the specification.

The terminology used herein is for the purpose of describing particular embodiments only and is not intended to be limiting of the exemplary embodiments. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on”, “directly connected to” or “directly coupled to” another element or layer, there are no intervening elements or layers present. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the exemplary embodiments.

Spatially relative terms, such as “beneath”, “below”, “lower”, “above”, “upper”, etc., may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Embodiments are described herein with reference to cross-section illustrations that are schematic illustrations of idealized embodiments (and intermediate structures). As such, variations from the shapes of the illustrations as a result, e.g., of manufacturing techniques and/or tolerances, are to be expected. Thus, these embodiments should not be construed as limited to the particular shapes of regions illustrated herein but are to include deviations in shapes that result, e.g., from manufacturing. For example, an implanted region illustrated as a rectangle will, typically, have rounded or curved features and/or a gradient of implant concentration at its edges rather than a binary change from implanted to non-implanted region. Similarly, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the exemplary embodiments.

Unless otherwise defined, all terms (including technical and scientific terms) used herein have the same meaning as commonly understood by one of ordinary skill in the art to which the exemplary embodiments belong. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

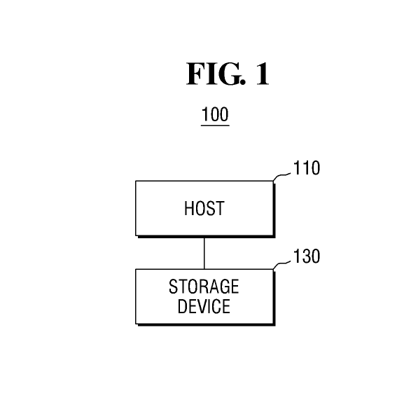

Hereinafter, a storage system according to an embodiment will be described with reference to FIG. 1.

FIG. 1 is a schematic diagram of a storage system according to an embodiment.

Referring to FIG. 1, the storage system 100 according to an embodiment may include a host 110 and a storage device 130. In other words, the storage system 100 may be implemented by a storage structure having a single storage device 130.

The host 110 may communicate with the storage device 130 using universal serial bus (USB), small computer system interface (SCSI), PCI express, ATA, parallel ATA (PATA), serial ATA (SATA), or serial attached SCSI (SAS).

The host 110 may perform deduplication and may transfer duplicated information to the storage device 130.

The storage device 130 may receive the duplicated information from the host 110 and may store the same. The duplicated data stored in the storage device 130 may be used in data placement, such as cache, wear leveling, etc.

Accordingly, the host 110 performs deduplication to increase deduplication efficiency and can also perform higher level deduplication, such as file-level deduplication or application-level deduplication. In addition, the host 110 provides the duplicated information to the storage device 130, and the storage device 130 may utilize the duplicated data in data placement.

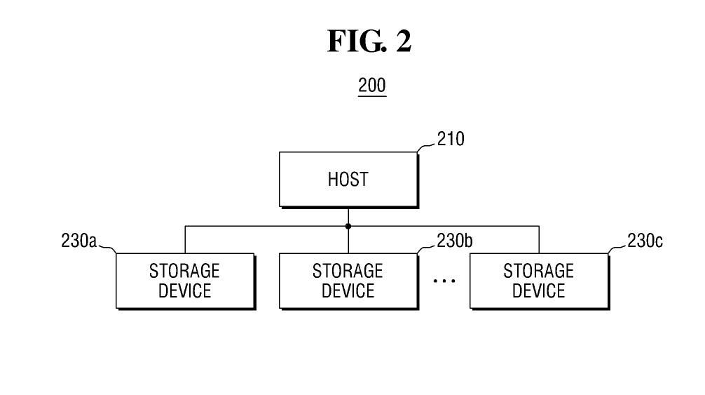

FIG. 2 is a schematic diagram of a storage system according to another embodiment. In FIG. 2, a host 210 and a plurality of storage devices 230a to 230c correspond to the host 110 and the storage device 130 shown in FIG. 1, respectively.

Referring to FIG. 2, the storage system 200 may include the host 210 and the plurality of storage devices 230a to 230c. In other words, the storage system 200 may be implemented by a storage structure including a plurality of storage devices 230a to 230c. The storage structure including a plurality of storage devices 230a to 230c may include a storage array having the plurality of storage devices 230a to 230c each constructed by a single node, and a distributed storage structure having the plurality of storage devices 230a to 230c divided into a plurality of nodes connected by a network.

Accordingly, the host 210 may demonstrate greater deduplication efficiency when performing deduplication by handling duplicated data of the plurality of storage devices 230a to 230c, in comparison to the deduplication efficiency of the storage system 100 shown in FIG. 1. In this case, each of the plurality of storage devices 230a to 230c may use the duplicated information transferred from the host 210 in data placement in consideration of cycle life, performance, etc., of each of the plurality of storage devices 230a to 230c.

The storage device (e.g., 130 and 230a to 230c) may be implemented by a solid state drive or a solid state disk (SSD). In exemplary embodiments, the storage device (e.g., 130 and 230a to 230c) is not limited to the SSD, but may be implemented in various manners. For example, the storage device (e.g. 130, and 230a to 230c) may be incorporated into a single semiconductor device implemented by a PC card (e.g., PCMCIA), a compact flash card (CF), a smart media card (SM/SMC), a memory stick, a multimedia card (e.g., MMC, RS-MMC and MMCmicro), an SD card (for example, SD, miniSD and microSD), and a universal flash memory device (e.g., UFS).

Hereinafter, for convenience, it is assumed that the storage system is implemented by a storage structure including a single storage device, similar to FIG. 1.

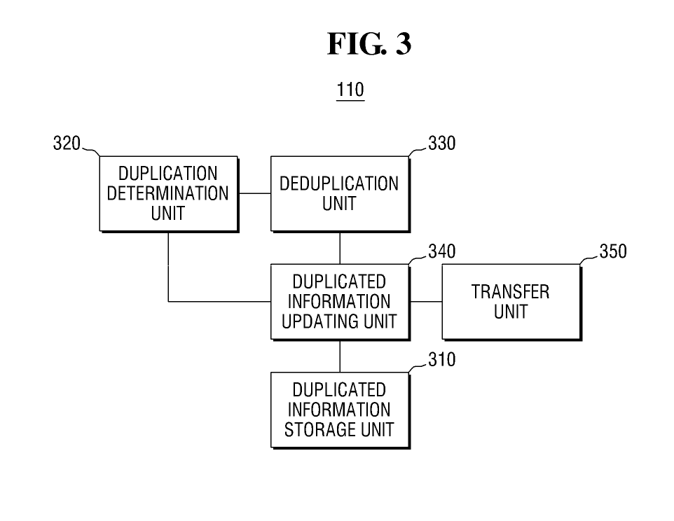

FIG. 3 is a detailed diagram of a host shown in FIG. 1.

Referring to FIG. 3, the host 110 may include a duplicated information storage unit 310, a duplication determination unit 320, a deduplicator 330, a duplicated information updater 340, and a transferor 350.

The duplicated information storage unit 310 may store duplicated information of the data stored in the storage device 130. According to an embodiment, the duplicated information may include a reference count, a reference level, etc. The reference count refers to a duplicated data amount or a count indicating valid/invalid data. For example, data having a reference count of −1 may mean invalid data, data having a reference count of 0 may mean deduped data, data having a reference count of 1 may mean unique data, and data having a reference count greater than 1 may mean duplicated data. The reference level refers to a level based on the range of the reference count recognized by the host 110 and the storage device 130. For example, level 1 may mean that the reference count is between 1 and 3, level 2 may mean that the reference count is between 4 and 10, and level 3 may mean that the reference count is greater than or equal to 11.

According to an embodiment, the duplicated information storage unit 310 may store duplicated information in the form of a mapping table with logical block addresses (LBAs) for data storage and link addresses for linking of data in each LBA.

The duplication determination unit 320 may determine whether write-requested data or delete-requested data from a user is duplicated data or not. According to an embodiment, the duplication determination unit 320 may determine whether the write-requested data or delete-requested data is duplicated in units of files, blocks, bytes, or bits.

For example, when it is determined whether the write-requested data or delete-requested data is duplicated in units of files or blocks, the duplication determination unit 320 may determine whether the write-requested data or delete-requested data is duplicated by comparing a signature of the write-requested data or delete-requested data with a pre-stored signature. The signature may be a hash value obtained using a hash function, but is not limited thereto. When it is determined whether the write-requested data or delete-requested data is duplicated in units of bytes or bits, the duplication determination unit 310 may determine whether the write-requested data or delete-requested data is duplicated by comparing the data stored in the storage device 130 with the write-requested data or delete-requested data through byte-wise comparison or bit-wise comparison.

Exemplary embodiments do not limit the method of the duplication determination unit 320 determining whether data is duplicated to those described herein. Rather, various methods or algorithms for determining sameness of data may be used based on the performance or use of the system.

If the write-requested data is duplicated data, the deduplicator 330 may delete the write-requested data.

The duplicated information updater 340 may update the duplicated information pre-stored in the duplicated information storage unit 310 based on the determination result. For example, if the write-requested data is duplicated data, the duplicated information updater 340 updates the reference count of the pre-stored data that is the same as the write-requested data in an increment of 1. If the delete-requested data is duplicated data, the duplicated information updater 340 updates the reference count of the pre-stored data that is the same as the delete-requested data in a decrement of 1.

If the duplication determination unit 320 determines that the write-requested data is not duplicated data, the transferor 350 may transfer the write-requested data to the storage device 130 through an application program interface (API).

If the duplication determination unit 320 determines that the delete-requested data is not duplicated data, the transferor 350 may transfer a TRIM command to the storage device 130 through a TRIM application program interface (TRIM API) to allow the storage device 130 to execute a TRIM function.

If the duplication determination unit 320 determines that the write-requested data or delete-requested data is duplicated data, the transferor 350 may transfer the duplicated information updated by the duplicated information updater 340 to the storage device 130. For example, the transferor 350 may modify the existing write API or TRIM API, and may transfer the duplicated information to the storage device 130 through the modified write API or TRIM API. Alternatively, a separate API for transferring duplicated information may be newly defined and the duplicated information may be transferred through the newly defined API.

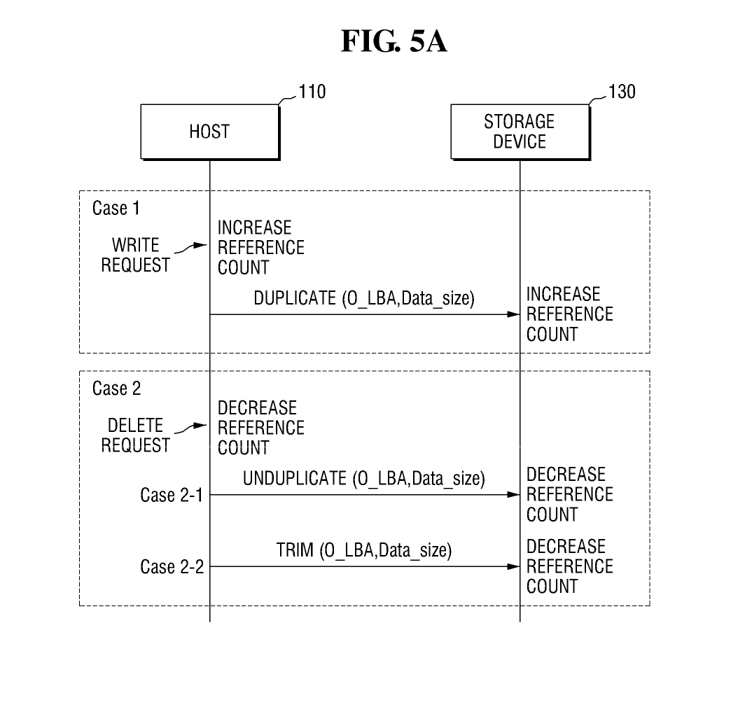

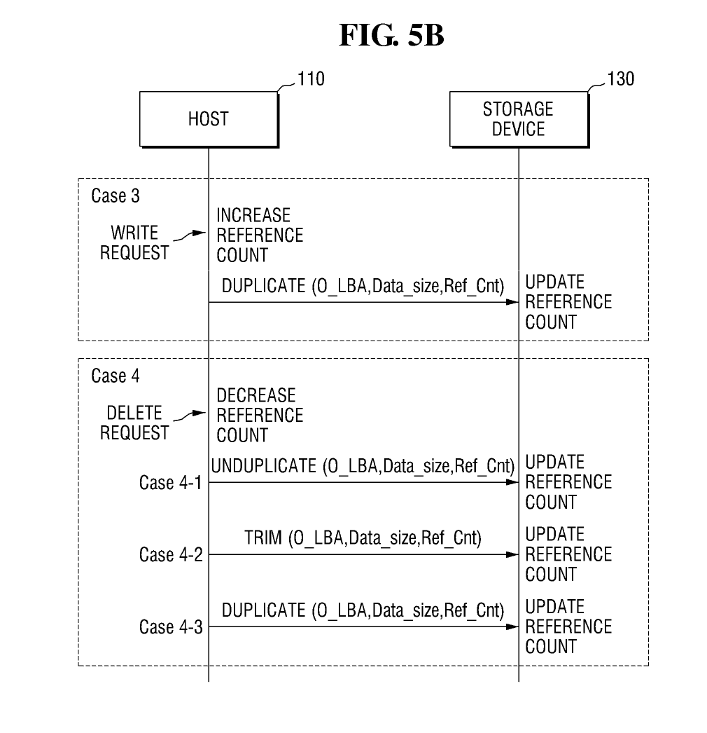

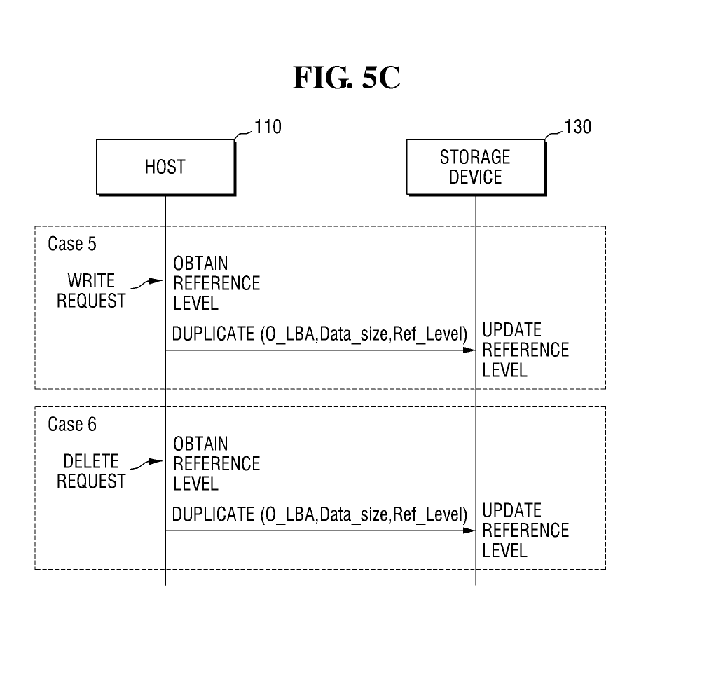

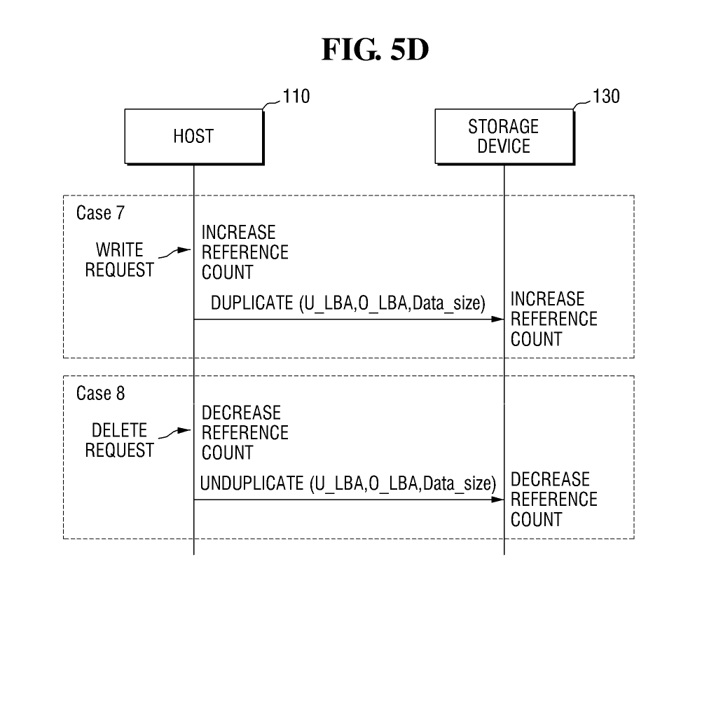

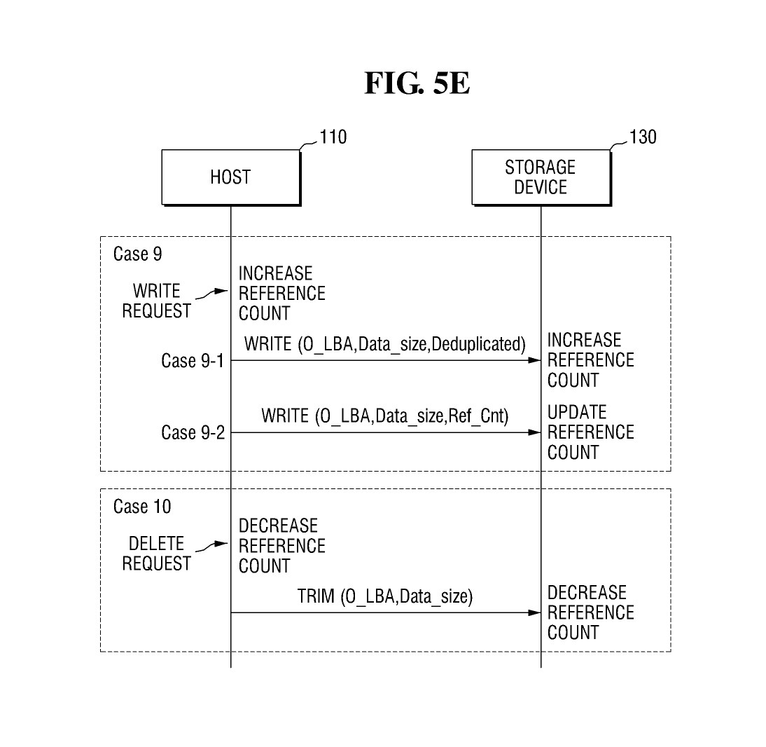

The operation of the transferor 350 transferring the duplicated information to the storage device 130 will later be described in detail with reference to FIGS. 5A to 5E.

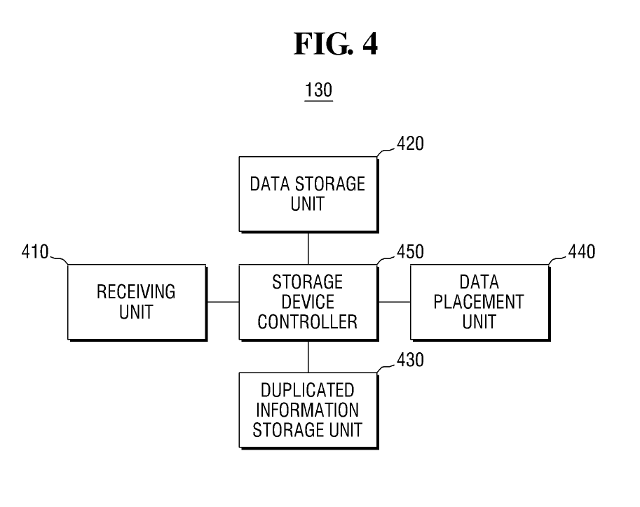

FIG. 4 is a detailed diagram of a storage device shown in FIG. 1.

Referring to FIG. 4, the storage device 130 may include a receiver 410, a data storage unit 420, a duplicated information storage unit 430, a data placer 440 and a storage device controller 450.

The receiver 410 may receive a write command and the write-requested data from the host 110 through a write API. The receiver 410 may receive a TRIM command from the host 110 through a TRIM API. In addition, the receiver 410 may receive duplicated information from the host 110.

The data storage unit 420 may store the write-requested data received from the host 110 through the write API. The data storage unit 420 may be a flash memory (e.g., a NAND flash memory), but the data storage unit 420 is not limited thereto. For example, the data storage unit 420 may also be other types of nonvolatile memories, such as PRAM, FRAM, or MRAM.

The duplicated information storage unit 430 may store the duplicated information received from the host 110. According to an embodiment, the duplicated information may include a reference count, a reference level, etc. The reference count refers to a duplicated data amount or a count indicating valid/invalid data. For example, data having a reference count of −1 may mean invalid data, data having a reference count of 0 may mean deduped data, data having a reference count of 1 may mean unique data, and data having a reference count greater than 1 may mean duplicated data. The reference level refers to a level based on the range of the reference count recognized by the host 110 and the storage device 130. For example, level 1 may mean that the reference count is between 1 and 3, level 2 may mean that the reference count is between 4 and 10, and level 3 may mean that the reference count is greater than or equal to 11.

The duplicated information stored in the duplicated information storage unit 430 may be stored and managed as meta data of data.

According to an embodiment, the duplicated information storage unit 410 may store duplicated information in the form of a mapping table with logical block addresses (LBAs) for data storage, physical block addresses (PBAs), and link addresses for linking of data in each LBA.

The data placer 440 may place data using the duplicated information stored in the duplicated information storage unit 430. For example, the data placer 440 may perform wear leveling, etc., based on the duplicated information.

The storage device controller 450 may control the overall operation of the storage device 130.

The storage device controller 450 may store the data received from the host 110 in the data storage unit 420 in response to the write command of the host 110. If the write-requested data, the logical block address LBA, and the write command are supplied together from the host 110 through the write API, the storage device controller 450 converts the logical block address LBA into the physical block address PBA and may store the write-requested data in a storage area of the data storage unit 420 corresponding to the converted physical block address PBA.

The storage device controller 450 may update the duplicated information pre-stored in the duplicated information storage unit 430 based on the duplicated information received from the host 110. In an exemplary embodiment, the storage device controller 450 may update the reference count or the reference level based on the received duplicated information.

FIGS. 5A to 5E illustrate a method of transferring duplicated information according to an embodiment.

Meanings of various API parameters used herein will now be described. In other words, U_LBA means a logical block address requested for a write operation or a delete operation from a user or a file system, O_LBA means a logical block address of the pre-stored data that is the same as data requested for a write operation or a delete operation, Data_size means a size of write- or delete-requested data (or pre-stored data that is the same as the write- or delete-requested data), Ref_Cnt means a reference count of the pre-stored data that is the same as the write- or delete-requested data, i.e., a value updated by the duplicated information updater 340, and Ref_Level means a reference level of the pre-stored data that is the same as the write- or delete-requested data, i.e., a value updated by the duplicated information updater 340. Data_size may be changed into the number of sectors (nSectorCount).

FIG. 5A illustrates an example of transferring duplicated information using a newly defined API between the host 110 and the storage device 130.

Referring to FIG. 5A, in a case where there is a write request of duplicated data from a user (Case 1), the host 110 increases a reference count for the pre-stored data that is the same as the write-requested data and transfers the duplicated information through a newly defined DUPLICATE API between the host 110 and the storage device 130. Parameters of the DUPLICATE API include O_LBA and Data_size. In other words, the host 110 transfers the parameters O_LBA and Data_size to the storage device 130 through the DUPLICATE API, thereby allowing the storage device 130 to update the reference count of the pre-stored data.

In a case where there is a delete request of duplicated data from a user of the host 110 (Case 2-1), the host 110 may transfer the duplicated data through a newly defined UNDUPLICATE API between the host 110 and the storage device 130.

Alternatively, an operation of the existing TRIM API is modified to be used in transferring the duplicated information (Case 2-2). In a related art, the storage device having received the TRIM command through the TRIM API performs a tagging operation on pertinent data to indicate the data is invalid. However, according to an embodiment, in a case where the storage device 130 receives the TRIM command, invalid tagging is performed such that the reference count is decreased if the reference count of the pertinent data at the time of receiving the TRIM command is greater than 1, and the reference count is decreased to −1 if the reference count is 1.

FIG. 5B illustrates another example of transferring duplicated information using a newly defined API between the host 110 and the storage device 130.

Referring to FIG. 5B, in a case where there is a write request of duplicated data from the user (Case 3), the host 110 transfers the duplicated information through a newly defined DUPLICATE API between the host 110 and the storage device 130. In this case, when compared to Case 1 shown in FIG. 5A, Ref_Cnt is further included as the parameter of the DUPLICATE API. After receiving the parameter Ref_Cnt, the storage device 130 updates the reference count of pertinent data based on the received Ref_Cnt.

In a case where there is a delete request of duplicated data from the user (Case 4), the host 110 transfers the duplicated information through a newly defined UNDUPLICATE API between the host 110 and the storage device 130 (Case 4-1). Duplicated information may be transferred through a TRIM API having a modified operation and parameter (Case 4-2). Alternatively, the host 110 may transfer the duplicated information through a newly defined DUPLICATE API between the host 110 and the storage device 130 (Case 4-3).

FIG. 5C illustrates still another example of transferring duplicated information using a newly defined API between the host 110 and the storage device 130.

Referring to FIG. 5C, in a case where there is a write request of duplicated data from the user (Case 5), the host 110 transfers the duplicated information through a newly defined DUPLICATE API between the host 110 and the storage device 130. In this case, when compared to Case 3 shown in FIG. 5B, the host 110 transfers Ref_Level, instead of Ref_Cnt. The host 110 transfers the duplicated information to the storage device 130 only when the reference level increases.

In a case where there is a delete request of the duplicated data from the user (Case 6), the host 110 transfers the duplicated information to the storage device 130 through the DUPLICATE API only when the reference level decreases.

Therefore, unlike in FIGS. 5A and 5B, the host 110 transfers the duplicated information to the storage device 130 only when the reference level is changed. Therefore, the number of transfers of the duplicated information is reduced.

FIG. 5D illustrates still another example of transferring duplicated information using a newly defined API between the host 110 and the storage device 130.

Referring to FIG. 5D, in a case where there is a write request of duplicated data from the user (Case 7), the host 110 transfers the duplicated information through a newly defined DUPLICATE API between the host 110 and the storage device 130. In this case, when compared to Case 1 shown in FIG. 5A, U_LBA is further included as the parameter of the DUPLICATE API.

In a case where there is a delete request of duplicated data from the user (Case 8), the host 110 transfers the duplicated information through a newly defined UNDUPLICATE API between the host 110 and the storage device 130.

In this case, the storage device 130 stores a mapping table having the same values as those of the mapping table of the host 110. Thus, even if an error is generated in the mapping table of the host 110 or the mapping table is deleted, the user requested address data can be accurately fetched, and the mapping table of the host 110 can be easily recovered from the mapping table of the storage device 130.

FIG. 5E illustrates still another example of transferring duplicated information using a modified write API.

Referring to FIG. 5E, in a case where there is a write request of duplicated data from the user (Case 9), the host 110 may transfer the duplicated information through a write API having a modified parameter or operation.

In Case 9-1, if ‘Deduplicated’ transferred through the write API is a true value, the storage device 130 recognizes the transferred data as duplicated data and updates the reference count by increasing the reference count of pertinent data without storing the pertinent data. However, if ‘Deduplicated’ transferred through the write API is a false value, the storage device 130 recognizes that the write-requested data is not duplicated data and stores the pertinent data.

In Case 9-2, if ‘Ref_Cnt’ transferred through the write API has Ref_Cnt greater than or equal to 2, the storage device 130 recognizes the transferred data as duplicated data and updates the reference count of the pertinent data based on the received ‘Ref_Cnt’ without storing the pertinent data. If Ref_cnt is 1, the storage device 130 recognizes that the write-requested data is not duplicated data and stores the pertinent data.

In a case where there is a delete request of duplicated data from the user (Case 10), the host 110 may transfer the duplicated data through TRIM API.

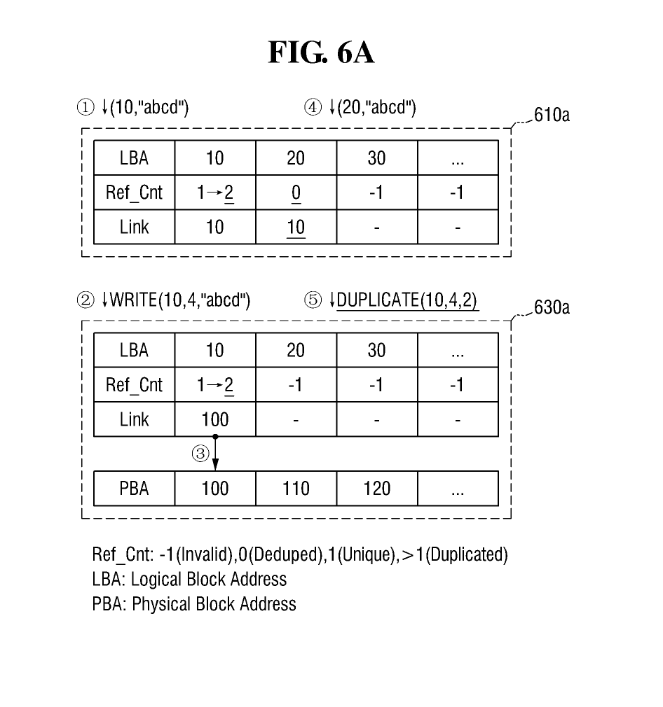

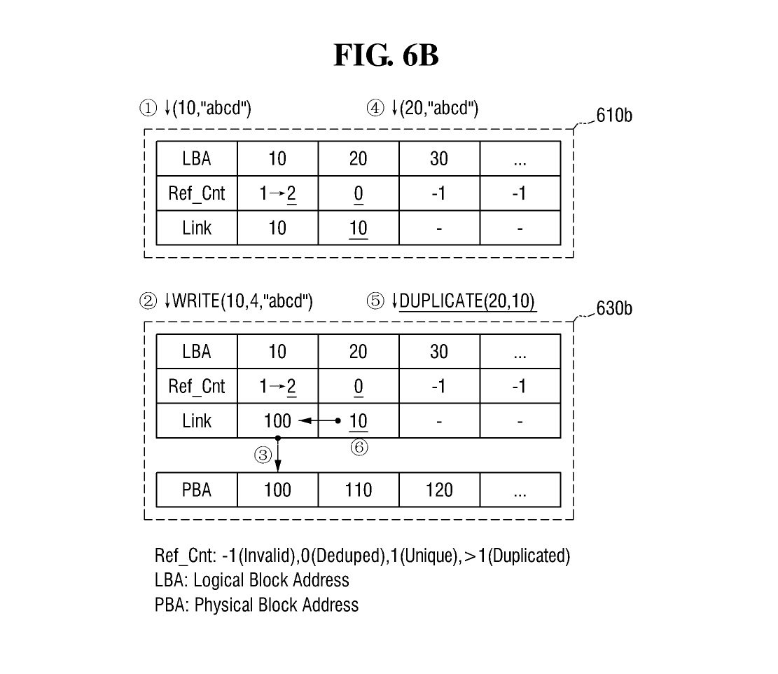

FIGS. 6A and 6B illustrate methods of operating mapping tables in a host and a storage device.

FIG. 6A illustrates mapping table operating methods in a host and a storage device in a case of using a DUPLICATE API according to an embodiment.

Referring to FIG. 6A, if there is a write request of data ‘abcd’ in an LBA ‘10’ from a user or file system, the host updates Ref_Cnt of the LBA ‘10’ of the mapping table 610a to ‘1’ and links the data of LBA ‘10’ to the LBA ‘10’. Thereafter, the host transfers LBA ‘10’, Data_size ‘4’ and the write-requested data ‘abcd’ to the storage device through the write API, and the storage device having received the transferred data updates Ref_Cnt of the LBA ‘10’ of the mapping table 630a to ‘1’, stores the write-requested data ‘abcd’ in a PBA ‘100’, maps the LBA ‘10’ to the PBA ‘100’ and links data of the LBA ‘10’ to PBA ‘100’.

Thereafter, if there is a write request of data ‘abcd’ in the LBA ‘20’ from the user or file system, since the write-requested data ‘abcd’ is duplicated data of the data stored in the LBA ‘10’, the host updates Ref_Cnt of the LBA ‘20’ to ‘0’ in its mapping table 610a, links the data of the LBA ‘20’ to the LBA ‘10’, and updates Ref_Cnt of the LBA ‘10’ to ‘2’.

Thereafter, the host transfers LBA ‘10’, Data_size ‘4’ and Ref_Cnt ‘2’ to the storage device through the DUPLICATE API, and the storage device having received the transferred data updates Ref_Cnt of the LBA ‘10’ to ‘2’ in its mapping table 630a based on the receive Ref_Cnt ‘2’. Since the mapping table of the host and the mapping table of the storage device are not completely equal to each other, and only reference counts of the data actually stored in the storage device are stored in the mapping table of the storage device, the size of the mapping table of the storage device can be advantageously reduced.

FIG. 6B illustrates mapping table operating methods in a host and a storage device in a case of using a DUPLICATE API including a write-requested logical block address (U_LBA) according to another embodiment.

When FIG. 6A is compared with FIG. 6B, FIG. 6B is different than FIG. 6A in that the write-requested logical block address (U_LBA) is transferred from the user through the DUPLICATE API. In other words, referring to FIG. 6B, the host 110 transfers the write-requested LBA from the user (U_LBA) ‘20’ and LBA (or linked address) of the pre-stored data that is the same as the write-requested data (O_LBA) ‘10’ to the storage device through the DUPLICATE API, and the storage device receives the data transferred from the host 110 and stores U_LBA ‘20’ and OLBA ‘10’ so as to have the same values as those of the mapping table 610b stored in the host 110. In this case, even if an error is generated in the mapping table 610b of the host 110 or the mapping table 610b is deleted, the user requested address data can be accurately fetched, and the mapping table 610b of the host 110 can be easily recovered from the mapping table 630b of the storage device 130.

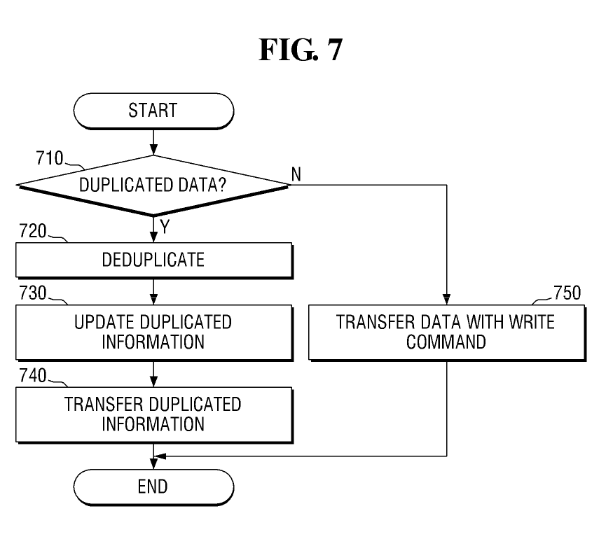

FIG. 7 is a flowchart illustrating a method of operating a host in response to a data write request according to an embodiment.

Referring to FIG. 7, in the method of operating a host in response to a data write request according to an embodiment, it is first determined whether the write-requested data is duplicated data (710). Thereafter, if it is determined in step 710 that the write-requested data is duplicated data, deduplication is performed on the write-requested data (720), and duplicated information of pre-stored data that is the same as the write-requested data is updated (730). Thereafter, the updated duplicated information is transferred to the storage device 130 (740). A method of the host 110 transferring the duplicated information to the storage device 130 is the same as described above with reference to FIGS. 5A to 5E.

If it is determined in step 710 that the write-requested data is not duplicated data, the host 110 transfers the write-requested data to the storage device 130 through the write API to store the write-requested data in the storage device 130 (750).

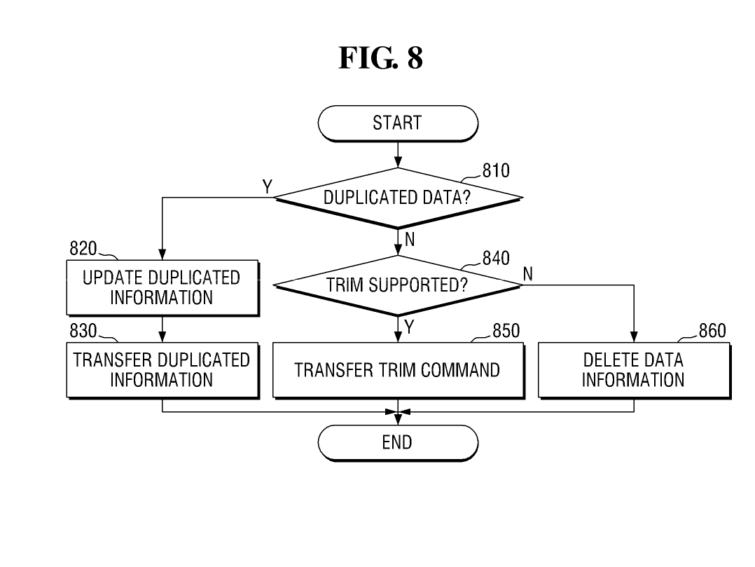

FIG. 8 is a flowchart illustrating a method of operating a host in response to a data delete request according to an embodiment.

Referring to FIG. 8, in the method of operating a host in response to a data delete request according to an embodiment, it is first determined whether delete-requested data is duplicated data (810). Thereafter, if it is determined in step 810 that the delete-requested data is duplicated data, duplicated information of pre-stored data that is the same as the delete-requested data is updated (820). Thereafter, the host 110 transfers the updated duplicated information to the storage device 130 (830). A method of the host 110 transferring the duplicated information to the storage device 130 is the same as described above with reference to FIGS. 5A to 5E.

If it is determined in step 810 that the delete-requested data is not duplicated data, it is determined whether the storage device 130 supports a TRIM function (840).

If it is determined in step 840 that the storage device 130 supports a TRIM function, the host 110 transfers a TRIM command to the storage device 130 through the TRIM API (850).

If it is determined in step 840 that the storage device 130 does not support a TRIM function, the host 110 deletes the delete-requested data (860).

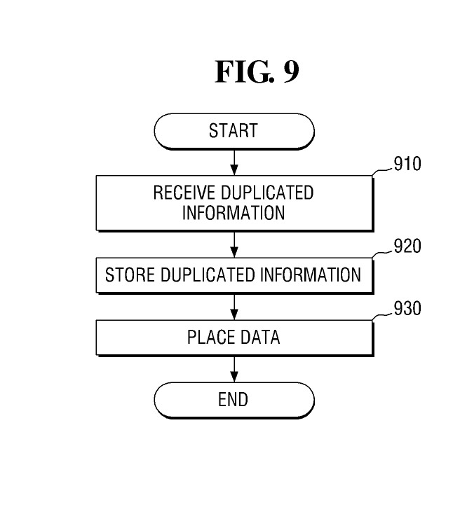

FIG. 9 is a flowchart illustrating a method of operating a storage device according to an embodiment.

Referring to FIG. 9, in the method of operating a storage device according to an embodiment, duplicated information is first received from the host 110 (910).

Thereafter, the received duplicated information is stored (920).

Then, data placement is performed using the stored duplicated information (930).

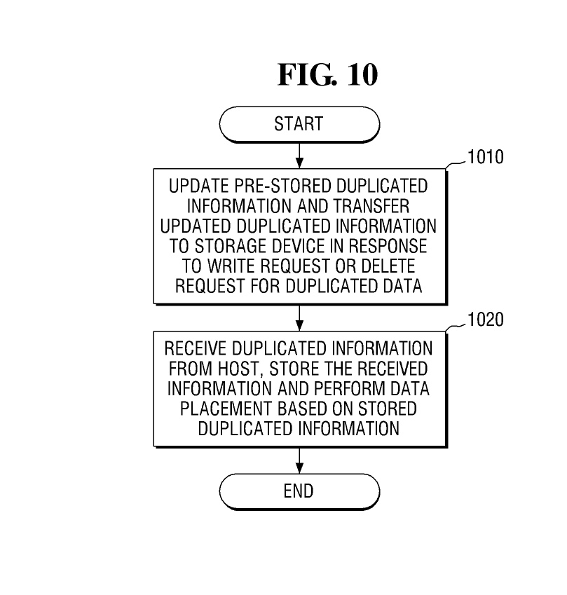

FIG. 10 is a flowchart illustrating a method of operating a storage system according to an embodiment.

Referring to FIG. 10, in the method of operating a storage system according to an embodiment, in response to a write request or a delete request of duplicated data, the host 110 first updates pre-stored duplicated information and transfers the updated duplicated information to the storage device 130 (1010).

Thereafter, the storage device 130 receives the duplicated information from the host 110, stores the received duplicated information, and performs data placement based on the stored duplicated information (1020).

An aspect of the exemplary embodiments can be embodied as computer readable codes on a computer readable recording medium. Also, functional programs, code, and code segments for implementing the program can be easily construed by programmers skilled in the art. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and so on. The computer readable recording medium can also be distributed over network coupled computer systems so that the computer readable code is stored and executed in a distributed fashion.

In an aspect of the exemplary embodiments, any of the duplication determination unit 320, the deduplicator 330, the duplicated information updater 340, the transferor 350, the receiver 410, the data placer 440, and the storage device controller 450 may include at least one processor, a hardware module, or a circuit for performing their respective functions.

While the exemplary embodiments have been particularly shown and described, it will be understood by those of ordinary skill in the art that various changes in form and details may be made therein without departing from the spirit and scope of the exemplary embodiments as defined by the following claims. It is therefore desired that the present embodiments be considered in all respects as illustrative and not restrictive. In other words, reference should be made to the appended claims rather than the foregoing description to indicate the scope of the exemplary embodiments.

1. A host device of a storage system, the host device comprising:
a duplicated information updater which is configured to update pre-stored duplicated information in response to a write request or a delete request for duplicated data; and
a transferor which is configured to transfer the updated duplicated information to a storage device in which the same data as the duplicated data is stored.

2. The host device of claim 1, further comprising:
a deduplicator which is configured to perform deduplication on the duplicated data in response to the write request for the duplicated data.

3. The host device of claim 1, wherein the duplicated information comprises a reference count or a reference level.

4. The host device of claim 1, further comprising:
a duplicated information storage unit which is configured to store the duplicated information.

5. A storage device of a storage system, the storage device comprising:
a receiver which is configured to receive duplicated information from a host device; and
a data placer which is configured to place data based on the received duplicated information.

6. The storage device of claim 5, further comprising:
a duplicated information storage unit which is configured to store the received duplicated information.

7. The storage device of claim 5, wherein the duplicated information comprises a reference count or a reference level.

8. A storage system comprising:
a host device which is configured to update pre-stored duplicated information in response to a write request or a delete request for duplicated data and transfer the updated duplicated information to a storage device; and
a storage device which is configured to store the updated duplicated information by receiving the updated duplicated information from the host device and place data based on the stored duplicated information.

9. The storage system of claim 8, wherein the host device is further configured to perform deduplication on a write-requested data in response to the write request for the duplicated data and transfer the duplicated data to the storage device.

10. The storage system of claim 8, wherein the storage device comprises a single solid state drive or a single solid state disk (SSD), or a plurality of SSDs.

11-20. (canceled)
